(19) United States
(12) Patent Application Publication
(10) Pub. No.: US 2003/0014610 A1
(43) Pub. Date: Jan. 16, 2003

(54) Experience sharing

(76) Inventors: Simon Mills, Tring (GB); Robert Gibbins, Birghton (GB)

Correspondence Address: Nixon & Vanderhye, 8th Floor, 1100 North Glebe Road, Arlington, VA, 22201-4714, US

(21) Appl. No.: 10/220,497

(22) PCT Filed: Mar. 28, 2001
(86) PCT No.: PCT/GB01/01390

(30) Foreign Application Priority Data
Mar. 29, 2000 (EP) 00302636.6

(51) Int. Cl. G06F 15/00

(52) U.S. Cl. 712/1

(57) ABSTRACT

A system for facilitating sharing of experience comprises a database (52) storing people identifiers and features of their experience. A user can query the database (52) from a client machine (1, 2) using details of a task that they are undertaking to obtained a ranked list of people with relevant experience.

The present invention relates to a method and apparatus for facilitating the sharing of experience.

In a small-scale operation, for instance the sales force of a small company, it is easy for every one to interact informally in canteens and corridors to exchange information and give each other the benefit of their experience. However, as an organisation grows in size it becomes increasingly difficult for these informal contacts to provide an advantageous pooling of experience. This is particularly a problem when the number of people involved rises above about 200.

Furthermore, as an organisation spreads over a larger area, either one large site or across different sites, many people will never have the opportunity to meet informally and exchange intelligence.

In WO99/64970, there is described what is termed a “contact intelligence data mining tool” for storing, processing, displaying and printing relational patterns between entities (e.g. business and other contacts). The tool allows proprietary individual contact data to be merged with accurate and up to date public information in order to explore the full scope or sphere of an individual's or business concern's scope of influence. An application program is provided which allows a user, typically a business person, to enter and store their private contact information. The contact intelligence data mining tool would also have access to a database containing publicly available information concerning multi-national corporation boards of directors. The data mining tool would allow the user to establish intelligently the contacts of their contacts and display, via a graphical user interface, the optimal relationship path to reach other desired contacts, i.e. their optimal “contact pathway”. A contact pathway is a graphical representation of the relational patterns between the user and the entities in the public and/or private databases. A further functionality of the tool includes allowing the user to learn the full sphere of their influence, and to learn their potential sphere of influence if the user were to create contacts with specific, yet presently unknown, persons.

As an alternative, the application program can be networked allowing multiple users to access news via the contact intelligence data mining tool. This would allow several sets of private data to be stored and thus matched to the public corporate contact information database to establish even wider spheres of contacts (i.e. influence). That is, not only can each member or employee of the entity using the system find out their personal sphere of influence (i.e. contacts and contacts of their contacts), but this could be done on an entity level. Such a network version of the data mining tool would include security measures to allow, for example, managers to access employees' private contact data, but disallow employees to access manager or fellow employee private contact data.

Thus, WO99/64970 teaches a tool and mechanism to permit people to see the identities of “contacts” and their relationships. The tool is neither intended nor configured to facilitate the exchange of information and experience.

Janna Systems Inc., a Canadian corporation, launched a product known as “Janna Contact Enterprise Microsoft SQL Server Addition” on Nov. 7, 1996 (see www.janna.com press release dated Nov. 7, 1996, Janna Contact Enterprise Microsoft SQL Server Addition). The press release describes the product as a collaborative relationship management system that provides enterprise users with integrated contact and document management, work group scheduling and communications features. The product also includes integrated opportunity management, sales forecasting and remote synchronisation for mobile users to provide a complete field force automation solution. However, there is nothing in the press release suggesting that the product is suitable for the exchange of information and sharing of experience, rather it provides a mechanism whereby documents can be shared.

Also of interest is the paper by Huffman from the proceedings of the International Conference on Information and Knowledge Management (CIKM) 1996, pages 99-105, entitled “Notes Explorer: Entity-based Retrieval in Shared, Semi-Structured Information Spaces”. The authors are with the price Waterhouse Technology Centre. In their paper, they describe an approach to semi-structured information sharing systems that goes beyond full-text search by taking advantage of both the structure of the document collections and a knowledge of what information types are important within the organisation sharing the information. They present an implemented indexing/browsing system called Notes Explorer that allows users to browse for entities (companies, people, etc) across a large semi-structured information space. Notes Explorer incorporates three components that are said to be key. (1) Automatic classification of document fields to recognise common entity and document collection types; (2) Entity-based browsing over multiple document collections, with type-dependent normalisation; and (3) Content-based filtering of browse results. While seemingly a powerful tool, the description of Notes Explorer given in the paper does not suggest that it is intended to facilitate the sharing of experience and information between users, other than that which is contained in documents.

Thus, there still exists a need for a method or system for facilitating the sharing of experience.

According to the present invention, there is provided a method of facilitating the sharing of experience, the method comprising:

storing a plurality of information sets in a database, each set comprising a performer identifier and information characterising one or more specific activity events performed by the performer identified by the performer identifier;

providing a data input user interface at a client for receiving a query which includes data relating to an activity event;

receiving the query data from the client at a server;

querying the database from the server to obtain the performer identifiers from information sets in which the activity characterising information matches, in at least one aspect, said query data; and

transmitting contact information relating to the or each obtained performer identifier to the client.

The database may comprise information abstracted from another database which performers (e.g. sales people) update with the progress of specific activity events (e.g. sales efforts).

Conveniently, the client comprises a web browser.

The database may be queried by a CGI or other server side process at a web server.

Preferably, the contact information is provided in a form whereby the client can automatically signal the related performer in response to a user input instructing it so to do for establishing bi-directional communication between the related performer and the source of the query.

According to the present invention, there is provided an apparatus for facilitating the sharing of experience, the apparatus comprising:

a database server making available a database to a plurality of database clients, the database holding a plurality of information sets, each set comprising a performer identifier and information characterising an activity performed by the performer identified by the performer identifier;

means for creating a data input user interface at a client for receiving activity characterising data from a further performer;

a server for receiving said activity characterising data from the client and querying data from database to obtain the performer identifiers from information sets in which the activity characterising information matches, in at least one aspect, said activity characterising data; and

means for transmitting contact information relating to the or each obtained performer identifier to the client which sent the activity characterising data.

Preferably, the means for creating a data input user interface comprises a web server.

Embodiments of the present invention will now be described, by way of example only, with reference to the accompanying drawings, in which:

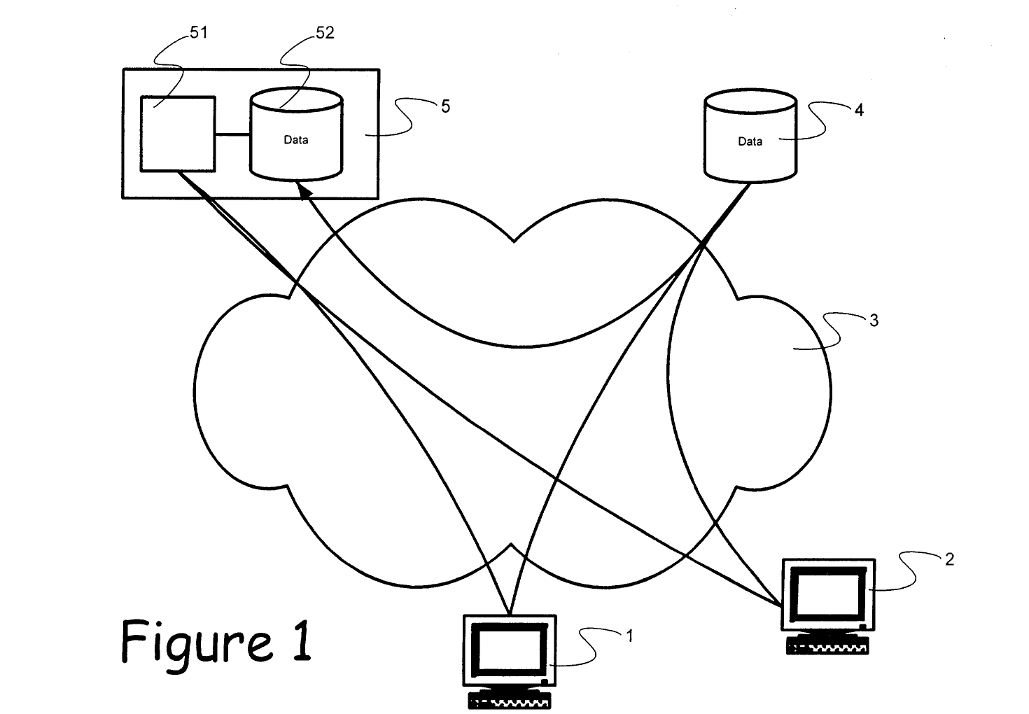

FIG. 1 illustrates a first system according to the present invention;

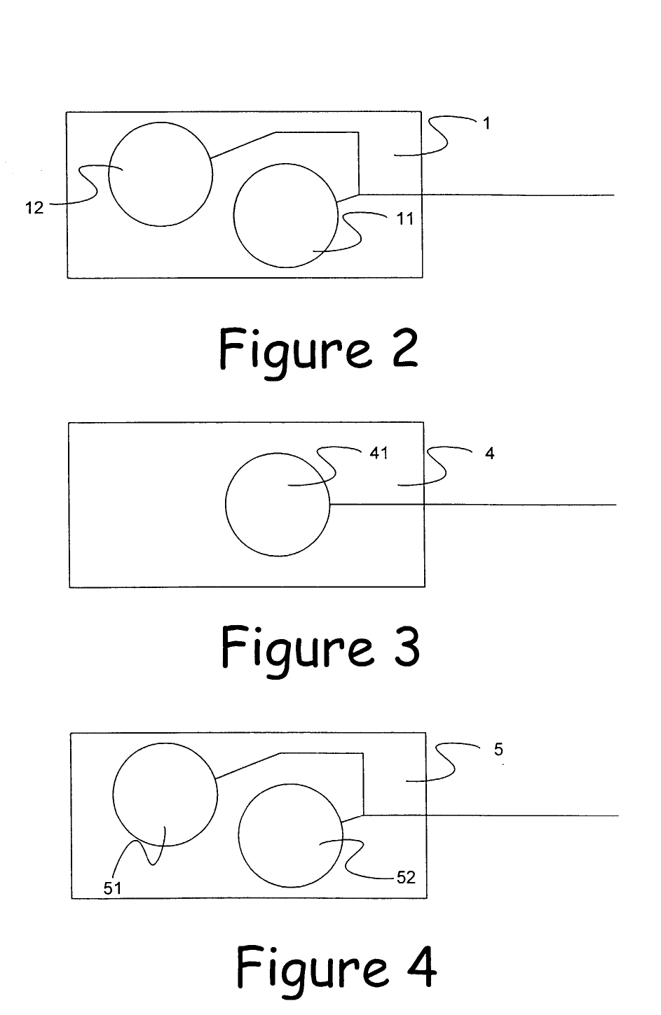

FIG. 2 illustrates a client from the system of FIG. 1;

FIG. 3 illustrates a database server machine from the system of FIG. 1;

FIG. 4 illustrates a web server machine from the system of FIG. 1;

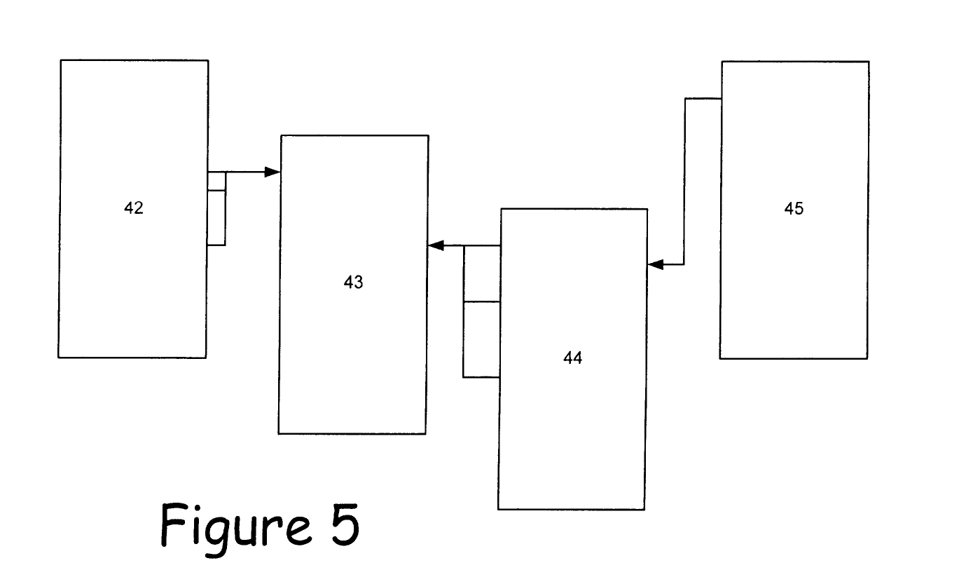

FIG. 5 illustrates a database at the database server machine;

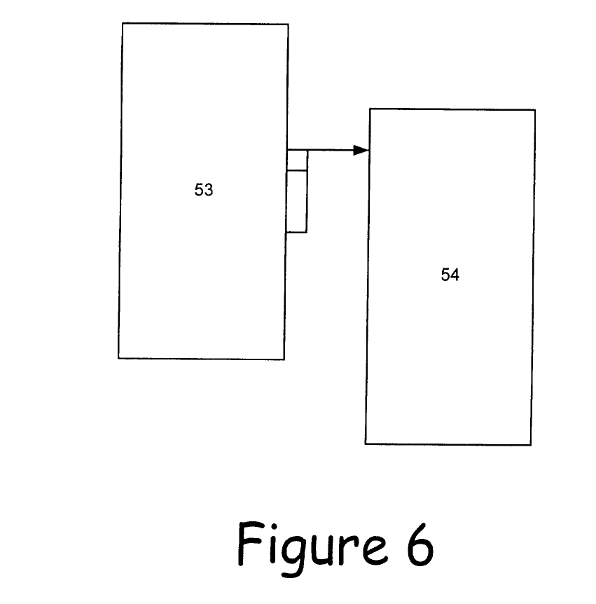

FIG. 6 illustrates a database at the web server machine;

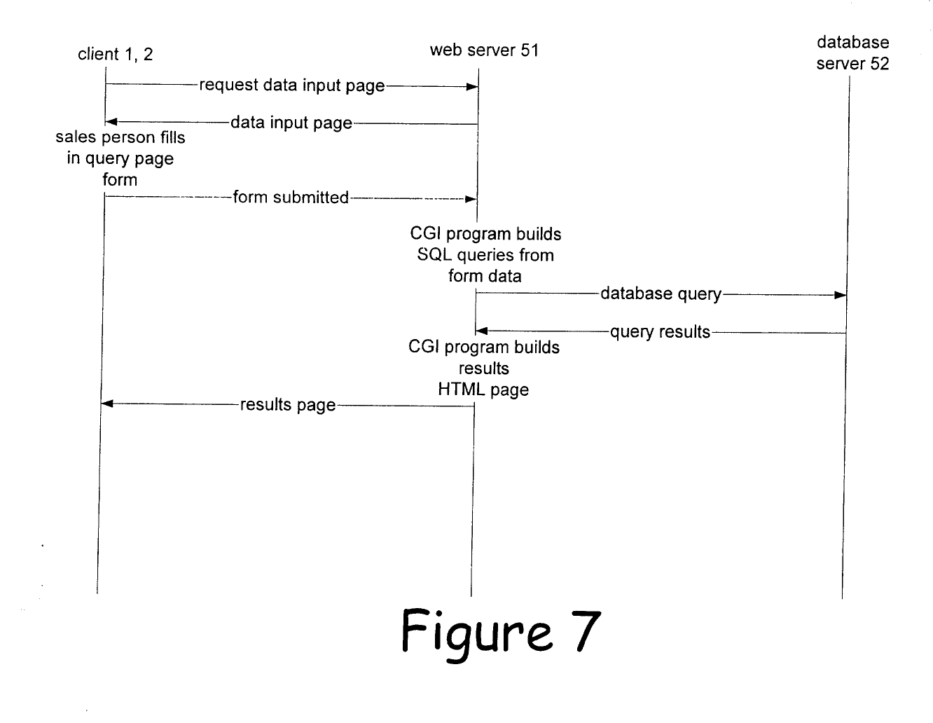

FIG. 7 illustrate the operation of the system of FIG. 1;

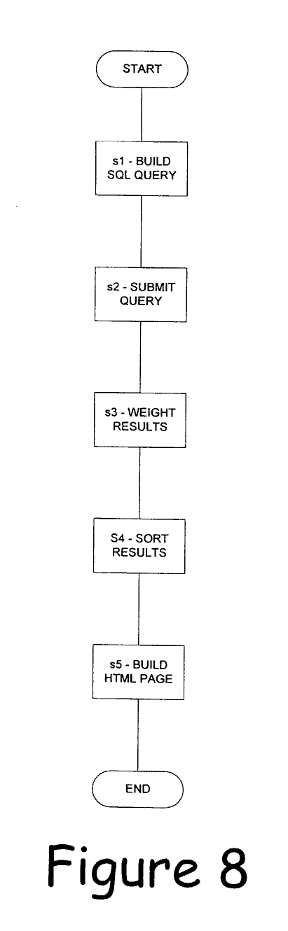

FIG. 8 is a flow chart illustrating the operation of a CGI program; and

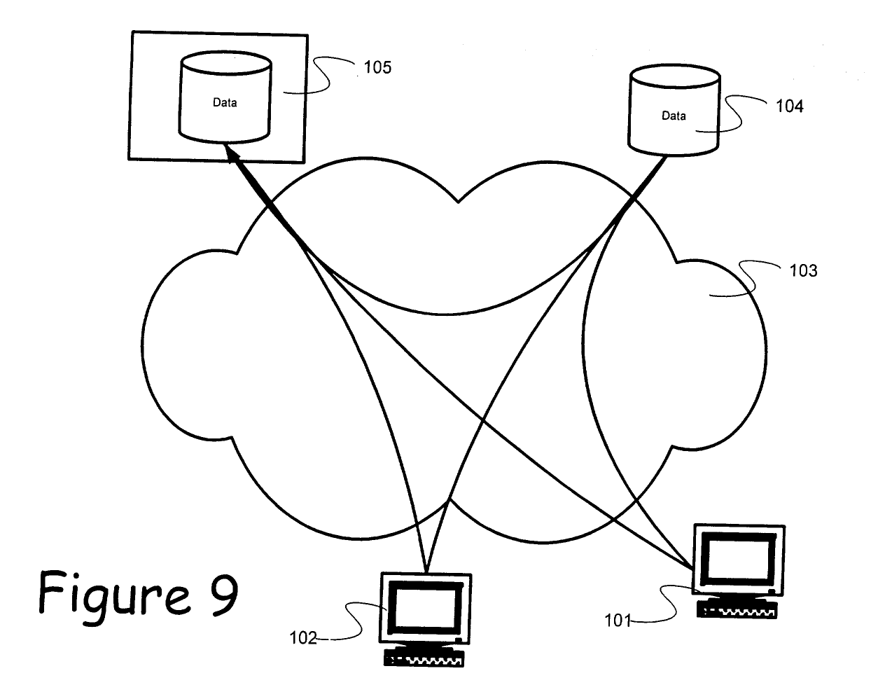

FIG. 9 illustrates a second system according to the present invention.

Referring to FIG. 1, first and second client machines 1, 2, representative of a large number of client machines used by sales personnel, are connected by a network 3 to a database server machine 4 and a web server machine 5. The database server machine 4 is the heart of a client-server sales force administration system.

Referring to FIG. 2, the first client machine 1 is a conventional personal computer running a web browser 11 and a database client program 12. The database client program 12 enables the user to interact with a database server 41 at the database server machine 4. The web browser 11 allows, amongst other things, the user to interact with a web server 51 at the web server machine 5.

The second client machine 2 is substantially identical to the first client machine 1.

Referring to FIG. 3, the database server machine 4 comprises a high-performance computer on which the database server 41 is running.

Referring to FIG. 4, the web server machine 5 also comprises a high-performance computer. The web server 51 and a further database server 52 run on the web server machine 5. The web server 51 includes CGI (Common Gateway Interface) programs that act as clients for the further database server 52.

Referring to FIG. 5, the database server 41 makes available a database comprising, in this example, first, second, third and fourth tables 42, 43, 44, 45. The first table 42 comprises a list of potential customers and columns for the industry sectors and sub-sectors in which the potential customers operate.

For example, a first potential customer may be in the telephone equipment reseller industry sector and in the retail industry sub-sector. A second potential customer may be in the same industry sector but in the OEM (original equipment manufacturer) sub-sector.

The second table 43 comprises a list of sales teams. Each sales team is associated with one or more potential customers. The third table 44 comprises a list of sales personnel. Each salesperson is associated with a sales team.

The fourth table 45 comprises a list of sales efforts, both successful and unsuccessful. Each sales effort is associated with the salesperson who made the effort. Each sales effort record includes fields for recording the details of the effort, including the target, i.e. a link to a record in the first table 42, the product or service involved, contact details, and the progress of the effort including the date of the most recent change to the record. Each sales person uses the database client program 12 running on their client machine 1, 2 to input information into the fourth table 45.

Referring to FIG. 6, the further database server 51 makes available a database comprising, in this example, first and second tables 53, 54. The first table 53 comprises contact details, e.g. telephone number and e-mail address, for sales personnel. The second table 54 comprises sales effort information records including, in each record, the target's industry sector and sub-sector, the product or service involved and the date of the record's most recent update.

The first and second tables made available by the further database server 52, are regularly updated from the first, third and fourth tables 41, 44, 45 made available by the database server 41 at the database server machine 4.

The operation of the present embodiment will now be described.

Referring to FIGS. 7 and 8, when a salesperson, using the first client machine 1, wishes to obtain the benefit of the experience of other salespeople, the salesperson requests a data input page from the web server 51 using the web browser 11 of the client machine 1. (This activity could of course be carried out on behalf of the salesman, for example by his/her assistant or secretary.) The web server 51 dispatches the requested page which is then displayed to the salesperson (or his aid) by the web browser 11. The data input page includes an HTML form with input elements so that the sales person (or his aid) can input the industry sector and sub-sector of his target and the product or service involved.

When the salesperson (or his aid) submits the form, a CGI program is triggered at the web server 51. This CGI program generates an SQL query (step s1) which is submitted to the database 52 (step s2). The query requests the contact details from the first table 53 and the product or service, the industry sector and sub-sector and the last updated date from the second table 54 where the product or service matches that entered by the salesperson, the contact details are not those of the salesperson making the query, the sale was won or lost (i.e. not pending) and the last update was less than 75 days ago. The results of this query are then ranked according to relevance. This ranking is achieved by giving a weighting to each result as follows (step s3): 50 points for a industry sector match, a further 25 points for an industry sub-sector match and 25—(the integer part of the result of the “number of days since last update” divided by 3). When the weightings have been calculated, the results are sorted according to their weightings in descending order (step s4).

The CGI program uses the ranked query results to generate an HTML document which list, in order of the ranking, the contact details of other salespeople whose experience is relevant (step s5). This page is dispatched to the web browser 11 and the salesperson can then contact the other salespeople ranking highly in the query results and who may be of assistance. E-mail addresses in the dispatched page can be clicked on to cause a local e-mail client to create a new message in the well-known manner.

Referring to FIG. 9, in a second embodiment, first and second client machines 101, 102, representative of a large number of client machines used by sales personnel, are connected by a network 103 to a database server machine 104 and a web server machine 105. The client machines 101, 102 and the database server machine 104 are identical to those of the first embodiment. However, the web server machine 105 differs in that the web server function is more integrated with the database function by use of Oracle Web Application Server 3.0. In this case, the ranking is effected by the internally generated SQL which is executed when a salesperson requests contact details for salespeople with relevant experience.

It has been found that the parameters used in the described embodiments to create the ranking are substantially optimal and that better results are not generally obtained by using more parameters. However, a workable system can be created using fewer or more parameters for the ranking.

It should also be understood that the databases need not be separate and that the query, for generating to ranked list of contact details, could be made directly to the sales force administration system's database.

Whilst embodiments of the present invention have been described with reference to a sales force, it will be appreciated that it has other applications. For instance, engineers could use the system to contact other engineers within an organisation with experience relevant to the task in hand and thereby reduce duplication of effort and speed up the design of new devices and apparatus. For instance, the industry sectors and sub-sectors could be replaced with technology classes, e.g. communications, computing hardware, software, mechanical structures, and sub-classes, e.g. analogue, digital, operating systems, applications programs etc. In this case, there would be advantage in having a greater number of levels in the hierarchy of classes and sub-classes and the ranking would be preferably based on relevance of technical field and number of records associated with each identified person. It will be appreciated that the described embodiments are examples of a generic approach in which experience is categorised and codified to be searchable in a meaningful and useful way using rather generic query language. The number of fields for classes of information and the number of levels in the hierarchy within the different fields can be selected according to the complexity of the experience space which is to be mapped. Generally the recorded data will include a class for each of the following:

What activity (for example, selling, designing, planning, building, manufacturing, demolishing, etc.), for which there may well be subclasses;

Description of the product or service which was the subject of the activity, for which there will generally be one or more subclasses;

Customer/commissioner, identifying the organisation, person or entity for whom the activity was performed, for which there will also be sector and sub-sector information (as in the sales example above);

Collaborators/contractors/associates identifying organisations or entities with whom the activity was performed;

Where the activity was performed, which may include sub classes for country, region, town/city, as well as possibly for characteristics of the place (desert, open sea, coast, underground, etc) depending upon the nature of the activity and the relevance of this type of information to likely enquirers; and

Identity of the person or team who carried out the activity (the performer), with contact details.

There may also be fields for contacts within the customer or associate organisations who were involved in the activity.

1. A method of facilitating the sharing of experience, the method comprising:
storing a plurality of information sets in a database, each set comprising a performer identifier and information characterising one or more specific activity events performed by the performer identified by the performer identifier;
providing a data input user interface at a client for receiving a query which includes data relating to an activity event;
receiving said query data from the client at a server;
querying the database from the server to obtain the performer identifiers from information sets in which the activity characterising information matches, in at least one aspect, said query data; and
transmitting contact information relating to the or each obtained performer identifier to the client.

2. A method according to claim 1, wherein the client comprises a web browser.

3. A method according to claim 2, wherein the database is queried by a CGI process of a web server.

4. A method according to claim 1, 2 or 3, wherein the contact information is provided in a form whereby the client can automatically signal the related performer in response to a user input instructing it so to do for establishing bi-directional communication between the related performer and the person who input the query.

5. A method of facilitating the sharing of experience, the method comprising:
providing a data input user interface at a client for receiving a query which includes data relating to an activity event;
receiving said query data from the client at a server;
querying, from the server, a database holding a plurality of information sets, each set comprising a performer identifier and information characterising one or more specific activity events performed by the performer identified by the performer identifier to obtain the performer identifiers from information sets in which the activity characterising information matches, in at least one aspect, said query data; and
transmitting contact information relating to the or each obtained performer identifier to the client.

6. A method of facilitating the sharing of experience, the method comprising:
providing a data input user interface at a client for receiving a query which includes data relating to an activity event;
transmitting said query data from the client to a server;
causing the server to query a database holding a plurality of information sets, each set comprising a performer identifier and information characterising one or more specific activity events performed by the performer identified by the performer identifier to obtain the performer identifiers from information sets in which the activity characterising information matches, in at least one aspect, said query data; and
receiving at the client, from the server, contact information relating to the or each obtained performer identifier.

7. An apparatus for facilitating the sharing of experience, the apparatus comprising:
a database server making available a database to a plurality of database clients, the database holding a plurality of information sets, each set comprising a performer identifier and information characterising specific activity events performed by the performer identified by the performer identifier;
means for creating a data input user interface at a client for receiving a query which includes data relating to an activity event;
a server for receiving said query data from the client and to query the database to obtain the performer identifiers from information sets in which the activity characterising information matches, in at least one aspect, said query data; and
means for transmitting contact information relating to the or each obtained performer identifier to the client which sent the query.

8. An apparatus according to claim 7, wherein the means for creating a data input user interface comprises a web server.
